(19) United States
(12) Patent Application Publication
(10) Pub. No.: US 2014/0042928 A1
(43) Pub. Date: Feb. 13, 2014

(54) LIGHT-EMITTING DEVICE

(71) Applicant: Canon Kabushiki Kaisha, Tokyo (JP)

(72) Inventors: Noriyuki Shikina, Yokohama-shi (JP); Susumu Oima, Tokyo (JP); Seishi Miura, Sagamihara-shi (JP); Taiji Tomita, Kawasaki-shi (JP)

(73) Assignee: Canon Kabushiki Kaisha, Tokyo (JP)

(21) Appl. No.: 13/960,533

(22) Filed: Aug. 6, 2013

(30) Foreign Application Priority Data
Aug. 8, 2012 (JP) 2012-176007

(51) Int. Cl. H05B 41/36

(52) U.S. Cl. CPC H05B 33/08
USPC 315/291

(57) ABSTRACT

A light-emitting device includes a plurality of organic EL elements including first electrodes, a second electrode, and organic compound layers therebetween, pixel circuits connected to the corresponding first electrodes, and a common power supply connected to the second electrode, in which at least a part of the organic compound layers is formed to extend from over the plurality of first electrodes to gap areas between the first electrodes, and a resistance between two adjacent first electrodes is less than a resistance between one of the first electrodes and the second electrode. Each of the organic EL elements receives an intermittent supply of a current from the corresponding pixel circuit, and during a period in which the current is stopped, a voltage equal to or less than a light emission threshold value is applied to the organic EL element.

### BACKGROUND OF THE INVENTION

1. Field of the Invention

The present disclosure relates to a light-emitting device, and in particular, to a light-emitting device in which a plurality of organic electroluminescence (EL) elements are formed on a substrate.

2. Description of the Related Art

Recently, self-light-emitting devices that can be used in flat panels have attracted attention. Examples of the self-light-emitting devices include a plasma light-emitting display element, a field emission element, an organic electroluminescence (EL) element, and an inorganic electroluminescence (EL) element.

Among these self-light-emitting devices, an organic EL element is an element in which a light-emitting layer included in organic compound layers emits light as a result of the organic compound layers interposed between two electrodes being supplied with a current. A light-emitting device in which only red organic EL elements are one-dimensionally arrayed is used as an exposure device of an electrophotographic printer. Color displays are classified into a light-emitting display element in which light-emitting layers of three colors, namely, green, blue, and red are separately provided and a light-emitting display element in which a color filter is provided so as to overlap with a light-emitting layer.

An organic EL element array produced by arranging a plurality of organic EL elements on a substrate can be driven by a passive matrix mode or an active matrix mode. Recently, an active matrix, in which an independent drive circuit is provided for each organic EL element, is mainly used. In such an active matrix organic EL element array, one of electrodes is separately provided for each organic EL element and this electrode is connected to the drive circuit. The other electrode is provided in common for all the organic EL elements.

From the standpoint of simplifying the production process, the organic compound layers except for a layer having a function that differs depending on the color are preferably formed in common in one going over the entire surface of each of the organic EL elements. However, when the organic compound layers are provided over the entire surface, the resistance between two adjacent pixels decreases and a drive current of one pixel leaks into the adjacent pixel. Consequently, an undesired pixel emits light, thereby decreasing the contrast. In the case of color organic EL elements in which adjacent pixels emit light having different colors, the different colors are mixed, resulting in a color shift.

Japanese Patent Laid-Open No. 2010-010576 teaches that, in order to prevent a current leakage between pixels in the active matrix mode, the lower limit of the resistance between adjacent pixels should be specified in terms of luminance of the display in the darkest state. U.S. Patent Publication No. 2004/0085014 proposes a method for increasing the resistance of a hole transport layer between pixels by UV irradiation. International Publication No. WO01/039272 discloses an organic EL device including a relief pattern that separates a charge transport layer along an electrode. These techniques aim to suppress the leakage of a current by increasing the resistance between pixels.

The prior arts disclose methods for preventing the leakage of a current between pixels by increasing the resistance of the organic compound layers between the pixels. However, increasing the resistance becomes difficult to be performed as a pixel size decreases in high resolution displays and printers. If the pixel size and the size between the pixels are reduced in a similar manner and a sheet resistance of the organic compound layers is invariant, the resistance between the pixels does not change. In contrast, the pixel resistance, that is, the resistance between two electrodes of an organic EL element increases in inverse proportion to the square of the dimension of the pixel. Since the dimension between the pixels is also small, it is very difficult to increase the resistance between the pixels so as to correspond to the increase in the resistance between the two electrodes by employing the above method in the related art.

### SUMMARY OF THE INVENTION

In the present disclosure, the current leakage between pixels is suppressed by a method different from the method in the related art.

According to a first aspect of the present disclosure, there is provided a light-emitting device comprising a plurality of organic EL elements including a plurality of first electrodes arranged on a substrate separately from each other with gaps therebetween, a second electrode disposed over the first electrodes, and organic compound layers disposed between each of the first electrodes and the second electrode; and a drive circuit for driving the organic EL elements. In the light-emitting device, at least a part of the organic compound layers is formed to extend from over the first electrodes to the gaps between the first electrodes, and a resistance between two adjacent first electrodes generated by the at least the part of the organic compound layers in the gap between the two adjacent first electrodes is less than a resistance between one of the first electrodes and the second electrode generated by the organic compound layers disposed therebetween. Further, the drive circuit supplies currents between the first electrodes and the second electrode during a first period, and during a second period in which the current supply is stopped, the drive circuit applies a voltage equal to or less than a light emission threshold value of the organic EL elements between the first electrodes and the second electrode.

According to a second aspect of the present disclosure, there is provided a method for driving a light-emitting device which comprises a plurality of organic EL elements and a drive circuit. In the light-emitting device, each of the organic EL elements includes a first electrode which is formed on a substrate separately from the first electrode of an adjacent organic EL element with a gap, a second electrode disposed over the first electrode, and organic compound layers disposed between the first electrode and the second electrode, at least a part of the organic compound layers is formed to extend from over the first electrode to the gap between the first electrodes of adjacent organic EL elements, and a resistance between two adjacent first electrodes generated by the at least the part of the organic compound layers in the gap is less than a resistance between the first electrode and the second electrode generated by the organic compound layers disposed therebetween. The method comprises alternately switching a first period during which the drive circuit supplies a current between the first electrode and the second electrode and a second period during which the current supply is stopped and the drive circuit applies a voltage equal to or less than a light emission threshold value of the organic EL elements between the first electrode and the second electrode.

According to the present disclosure, in a light-emitting device including organic EL elements, even when a pixel resistance is increased by a decrease in a pixel size, light emission due to a leakage current can be prevented without increasing the resistance between pixels.

Further features of the present disclosure will become apparent from the following description of exemplary embodiments with reference to the attached drawings.

### BRIEF DESCRIPTION OF THE DRAWINGS

FIG. 1 is a schematic cross-sectional view of a light-emitting device.

FIG. 2 is an equivalent circuit diagram of a light-emitting device.

FIG. 3 is a plan view of pixels.

FIG. 4A is a graph showing the relationship between a current-voltage characteristic of an organic EL element and a resistance between pixels in the case where a pixel size is large.

FIG. 4B is a graph showing the relationship between a current-voltage characteristic of an organic EL element and a resistance between pixels in the case where a pixel size is small.

FIGS. 5A and 5B are each a graph showing a response of an adjacent pixel when a voltage is applied to a pixel.

FIGS. 6A to 6C are each a graph showing a voltage between electrodes of an adjacent pixel when an alternating voltage is applied to a driven pixel.

FIG. 7 is a graph showing a change in the chromaticity of blue with respect to the frequency when an alternating voltage is applied to a blue pixel.

FIG. 8 is a schematic view of a light-emitting device according to a first exemplary embodiment.

FIG. 9 is a circuit diagram of a pixel in the first exemplary embodiment.

FIG. 10 is a timing chart illustrating an operation of the first exemplary embodiment.

FIG. 11 is a schematic view of a light-emitting device according to a second exemplary embodiment.

FIG. 12 is a timing chart illustrating an operation of the second exemplary embodiment.

FIGS. 13A and 13B are each a plan view of an exposure device according to a third exemplary embodiment.

FIG. 14 is a schematic view of an image forming apparatus according to the third exemplary embodiment.

### DESCRIPTION OF THE EMBODIMENTS

### Structure of Organic EL Element

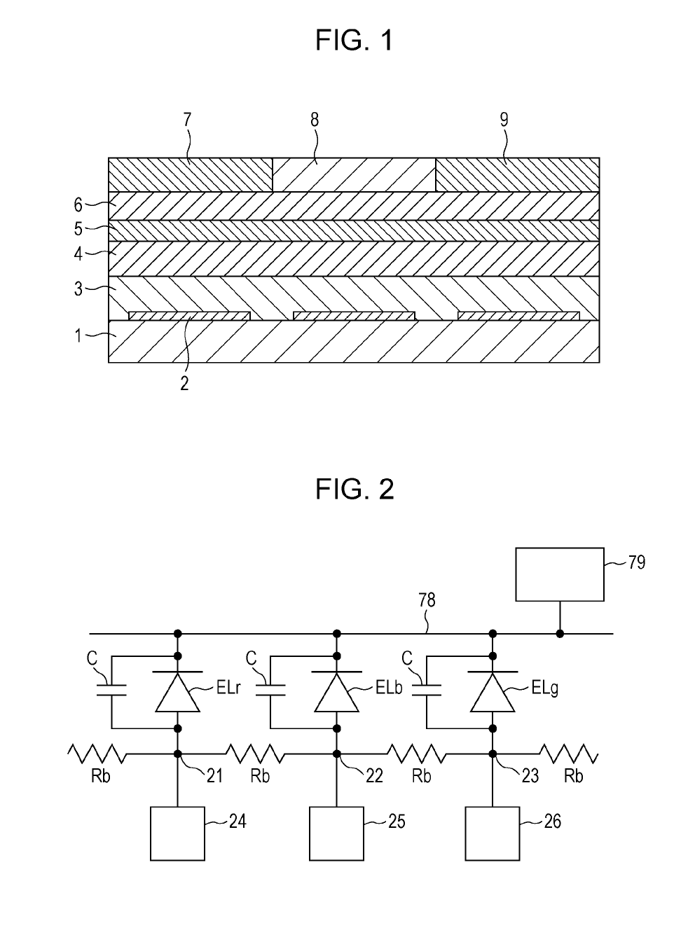

FIG. 1 is a cross-sectional view of a light-emitting device in which organic EL elements are arrayed, according to an embodiment of the present disclosure.

A first electrode 2, a charge transport layer 3, a light-emitting layer 4, and a second electrode 5 are stacked in the vertical direction to form three organic EL elements ELᵣ, EL_{b}, and EL_{g} (where subscripts r, b, and g represent that the organic EL elements are disposed under a red color filter, a blue color filter, and a green color filter, respectively). These organic EL elements of three colors are regularly arranged to form one light-emitting device. In addition to the charge transport layer 3 between the first electrode 2 and the light-emitting layer 4, another charge transport layer (not shown) may be provided between the light-emitting layer 4 and the second electrode 5. Each of the charge transport layers may include a plurality of layers having different functions.

In the case where a current flows from the first electrode 2 to the second electrode 5, the first electrode 2 functions as an anode and the second electrode 5 functions as a cathode. The charge transport layer 3 generates holes and injects the holes into the light-emitting layer 4. In contrast, in the case where a current flows from the second electrode 5 to the first electrode 2, the first electrode 2 functions as a cathode and the second electrode 5 functions as an anode. The charge transport layer 3 generates electrons and injects the electrons into the light-emitting layer 4.

In addition, the first electrode 2 and the second electrode 5 form a parasitic capacitance in which the charge transport layer 3 and the light-emitting layer 4 function as a dielectric.

The first electrodes 2 are separately formed on a substrate 1 for respective organic EL elements. The charge transport layer 3, the light-emitting layer 4, and the second electrode 5 are provided thereon as layers that are common to all the organic EL elements. A sealing film 6 covers the second electrode 5. A red color filter 7, a blue color filter 8, and a green color filter 9 are formed on the sealing film 6 at positions facing the first electrodes 2.

FIG. 1 illustrates an example of a light-emitting device in which the light-emitting layer 4 emits white light and three colors are formed by using the color filters. Alternatively, the light-emitting device may include organic EL elements in which light-emitting layers separately emit light of different colors without using color filters. In this case, the light-emitting layers are separately formed for the respective colors, while the charge transport layer is provided in common for all the light-emitting layers.

The charge transport layer 3 and the light-emitting layer 4 are disposed not only on the first electrodes 2 but also on positions between adjacent first electrodes 2.

FIG. 2 is an equivalent circuit diagram of the light-emitting device illustrated in FIG. 1.

It is assumed that a current flows from the first electrode 2 to the second electrode 5, and the organic EL elements ELᵣ, EL_{b}, and EL_{g} are each represented as a diode. Pixel circuits 24, 25, and 26 are respectively connected to nodes 21, 22, and 23 corresponding to the first electrodes 2. A common electrode 78 corresponding to the second electrode 5 is connected to a common power supply 79, and a constant voltage V_{com} is applied to the common electrode 78. A capacitance C is a parasitic capacitance formed by the first electrode and the second electrode. The node 21 and the node 22, and the node 22 and the node 23 are respectively connected by a resistance Rb between pixels. The resistance Rb between pixels is a resistance formed by organic compound layer disposed between the pixels. In this embodiment, the charge transport layer 3 and the light-emitting layer 4 correspond to the organic compound layers that form the resistance.

The first electrodes 2 are arranged with gaps therebetween so that the organic EL elements are independently driven for each pixel. However, the organic compound layers such as the light-emitting layer and the charge transport layer, and the second electrode layer are continuously formed in common for all the pixels so as to extend to an adjacent first electrode, except for a case where materials and film thicknesses of these layers are different for respective pixels.

The organic compound layers located between two adjacent first electrodes 2 determine the electric resistance between pixels. In particular, the charge transport layer 3 mainly determines the resistance between pixels since the charge transport layer 3 is composed of a material having a resistivity lower than that of the light-emitting layer 4 in order to decrease a drive voltage. In the case where at least a part of the organic compound layers is common to adjacent pixels, a resistance is generated between the pixels. Alternatively, even in the case where all the organic compound layers are patterned, when a part of the organic compound layers of the pixel physically connects to each other, a finite resistance is generated between the pixels.

A current passing through the first electrode 2 not only flows in the light-emitting layer of the pixel but also leaks to an adjacent pixel through the resistance Rb between the pixels, and causes the light-emitting layer of the adjacent pixel to emit light. An organic compound layer, such as the charge transport layer 3, disposed between the light-emitting layer 4 and the first electrode 2 mainly relates to the leakage of the current. However, when the light-emitting layer 4 has a resistance lower than that of the charge transport layer 3, the light-emitting layer 4 also relates to the leakage. An organic compound layer may be provided between the light-emitting layer 4 and the second electrode 5. However, the second electrode 5 is an electrode common to pixels, and thus a current flowing between the pixels through the organic compound layers does not cause a problem.

A pair of the pixel circuit 24 and the organic EL element ELᵣ, a pair of the pixel circuit 25 and the organic EL element EL_{b}, and a pair of the pixel circuit 26 and the organic EL element EL_{g} each constitute one pixel, and the three pixels having different colors form one unit of a color display. A plurality of the units are periodically arranged to form a light-emitting device such as a color display device.

In the case where the organic EL elements are current-driven, the pixel circuits 24, 25, and 26 are current sources for supplying a current to the organic EL elements in accordance with the gradation. In the case where an organic EL element is caused to emit light, the pixel circuit supplies a current corresponding to the luminance to the first electrode. In the case where the organic EL element is turned off, the current is controlled to zero. A specific example of the pixel circuit is illustrated in FIG. 9, and described in detail in a first exemplary embodiment described below.

In the case where the organic EL elements are voltage-driven, the pixel circuits are each equivalent to a switch that connects a constant voltage source to each of the organic EL elements. The pixel circuit causes the organic EL element to emit light by closing the switch to apply a voltage to the first electrode. When the switch is cut off, the charge accumulated in the parasitic capacitance C is discharged through the organic EL element, and the organic EL element is turned off.

### Current Leakage Between Pixels

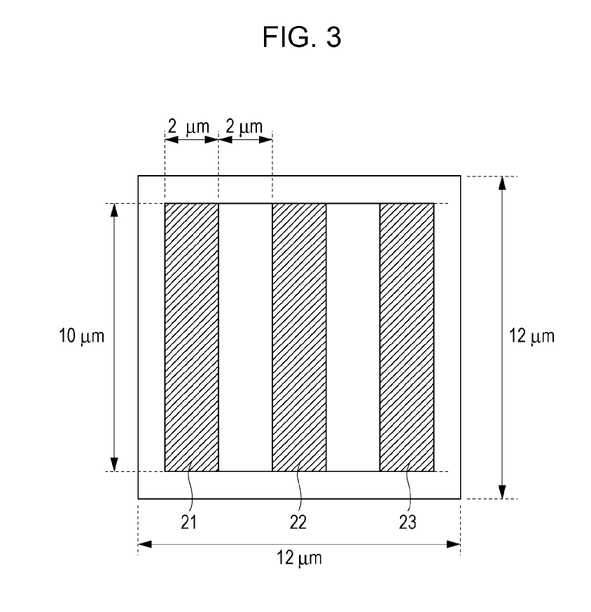

FIG. 3 is a plan view of three organic EL elements. FIG. 3 illustrates an example of a pixel arrangement of an organic EL light-emitting device used in an electronic view finder of a camera. In FIG. 3, three pixels of red, blue, and green occupy a region of a 12-μm square. The first electrode of each of the organic EL elements has a rectangular shape of 10 μm×2 μm, and the gap between the pixels is 2 μm.

The charge transport layer 3 is composed of an organic compound that will be described in detail in the first exemplary embodiment. The sheet resistance of the charge transport layer 3 is 30 GΩ/sq., and the resistance between pixels is 6 GΩ. It is assumed that the contribution of the light-emitting layer 4 to the resistance between pixels is negligible.

When this organic EL element is caused to emit light at a luminance of 1,000 cd/m², a current of 100 A/m² is necessary on the assumption that the luminous efficiency is 10 cd/A. Since the first electrode has a rectangular shape of 10 μm×2 μm, a current per pixel is 2 nA. When it is assumed that a voltage of 5 V is generated between the first electrode and the second electrode, the pixel resistance is calculated to be 2.5 GΩ, which is approximately the same as the resistance between pixels of 6 GΩ.

In the case of a pixel having a size 10 times the size described above, namely, a size of 100 μm×20 μm, the pixel resistance is calculated to be 25 MΩ, which is significantly lower than the resistance between pixels of 6 GΩ. When the pixel size is on the order of 10 μm, the pixel resistance becomes the same as or higher than the resistance between pixels.

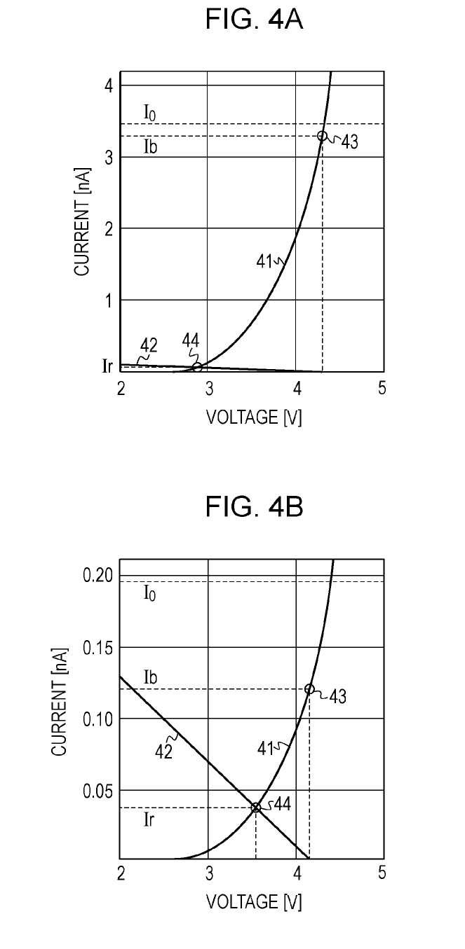

FIGS. 4A and 4B are each a graph showing a current-voltage characteristic of an organic EL element and the relationship between a voltage and a current of a driven pixel and those of a pixel adjacent to the driven pixel. The axis of abscissa represents a voltage between two electrodes of an organic EL element, and the axis of ordinate represents a current flowing in the organic EL element.

The current-voltage characteristic of an organic EL element is represented by a curve 41. A minimum voltage at which light emission occurs is referred to as a “threshold voltage.” At a voltage equal to or less than the threshold voltage Vₜₕ, a current does not flow and light is not emitted. When the voltage exceeds the threshold value, the current rapidly increases with respect to the voltage. In this example, the light emission threshold voltage is about 2.6 V.

The coordinates of an operating point 43 represent a voltage Vb and a current Ib of a blue organic EL element. A ratio of the voltage Vb to the current Ib, that is, the pixel resistance Ra of the organic EL element is a slope of a straight line joining the origin (not shown) of the figure and the coordinate values (Vb, Ib) of the operating point 43.

It is assumed that a drive current I₀ is supplied from a blue pixel circuit and that no current is supplied from a red pixel circuit and a green pixel circuit that are adjacent to the blue pixel circuit. In this case, the voltage Vb and the current Ib of the driven blue organic EL element, and a voltage Vr and a current Ir of the adjacent red organic EL element satisfy the relationship represented by formula (1):

Ir=(Vb−Vr)/Rb (1)

The voltage Vr and the current Ir are represented by the coordinates of an intersecting point 44 between the curve 41 and a straight line 42 that passes through the position of Vb on the axis of abscissa and that has a slope of Rb in FIGS. 4A and 4B. Regarding another adjacent pixel disposed on the opposite side, the voltage and the current of the adjacent organic EL element are the same as those of the adjacent red organic EL element. The drive current I₀ is the sum of the currents flowing in the three organic EL elements.

FIG. 4A shows a case where the pixel size is on the order of 100 μm. In FIG. 4A, the resistance Rb between pixels is sufficiently higher than the pixel resistance Ra. The slope of the straight line 42 is substantially horizontal.

FIG. 4B shows a case where the pixel size is 10 μm×2 μm, which is illustrated in FIG. 3. When the pixel size is reduced, the pixel resistance Ra increases and the drive current decreases. The resistance Rb between pixels is the same as that in FIG. 4A. However, the scale of the axis of ordinate of FIG. 4B is enlarged as compared with that of FIG. 4A, and thus the slope of the straight line 42 is largely drawn in FIG. 4B. When the pixel resistance Ra becomes substantially the same as the resistance Rb between pixels, (the reciprocal of) the slope of the straight line 42 increases, and the current Ib of the blue pixel that is caused to emit light is close to the current Ir of the red pixel that is in a turned-off state. In addition, the resistance Ra′ of the pixel in a turned-off state also becomes substantially the same as the pixel resistance Ra.

A ratio of the leakage current (current flowing in the red or green organic EL element in the above example) Ir to the current Ib flowing in the driven organic EL element (blue organic EL element in the above example) is represented by formula (2) using the pixel resistance Ra of the driven organic EL element, the pixel resistance Ra′ of the organic EL element in which the leakage current flows, and the resistance Rb between the pixels:

Ir/Ib=Ra/(Rb+Ra′) (2)

Since the luminance is substantially proportional to the current, the left-hand side of formula (2) may be considered to be a ratio of the luminance of red or green to the luminance of blue. When this value increases, a color shift occurs. It is necessary that the left-hand side of formula (2) be equal to or less than a permitted value. When the pixel resistance Ra and the resistance Rb between the pixels become substantially the same, the pixel resistance Ra′ and the pixel resistance Ra also become substantially the same and a color shift occurs.

In a light-emitting device including organic EL elements that emit white light or light of a single color other than white, the left-hand side of formula (2) represents a ratio of the luminance of a pixel that is in a turned-off state and is disposed adjacent to a driven pixel to the luminance of the driven pixel that emits light. When this value is close to 1, the contrast of brightness becomes low.

The pixel resistance Ra also depends on the current. Even in the same pixel size, a pixel resistance at a low luminance is higher than a pixel resistance at a high luminance. Even when a pixel resistance during light emission at the maximum luminance is lower than the resistance between pixels, a pixel resistance during light emission at a low luminance may be higher than the resistance between the pixels. In this case, since the ratio of the luminance of a pixel in a turned-off state to the luminance of a pixel that emits light is close to 1 even at the low luminance, a precise gradation display cannot be performed.

A state at the lowest luminance is a turned-off state. In this case, since the drive current is zero, no leakage current flows. Except for the turned-off state, the leakage current generated when light is emitted at a minimum drive current causes a problem. The pixel resistance Ra to be compared with the resistance Rb between pixels is a pixel resistance when light is emitted at a minimum drive current that is not zero.

In the pixel dimensions illustrated in FIG. 3, when 256 gradations are displayed at a maximum luminance of 1,000 cd/m², the minimum luminance is about 4 cd/m² and the minimum pixel current is 8 pA. In this case, the voltage is about 2.7 V and the pixel resistance is 340 GΩ, which is significantly higher than the resistance between pixels, i.e., 6 GΩ. Accordingly, a leakage current that is substantially the same as the drive current flows in the adjacent pixel in a turned-off state. As described above, it is very difficult to make the resistance between the pixels higher than the pixel resistance in a light-emitting device having such small pixel dimensions.

### Driving Method

In the present disclosure, regarding a light-emitting device in which non-negligible light emission occurs in a pixel which should be in the darkest state because the pixel resistance is substantially the same as or higher than the resistance between pixels, the luminance in the darkest state is suppressed to a permitted value or less by employing a particular driving method without increasing the resistance between pixels.

The current and the voltage of an organic EL element given by formulae (1) and (2) are a current and a voltage in a stationary state in which a constant light-emitting state is continued. A transient current that flows in red and green organic EL elements immediately after the start of light emission from a blue organic EL element changes with time by the effect of the parasitic capacitance C.

The present disclosure utilizes the following: From the time when a certain pixel starts light emission to the time when the voltage between electrodes of an adjacent pixel reaches a light emission threshold voltage, it is necessary to charge the parasitic capacitance C through the resistance Rb between pixels and thus a certain period of time is required.

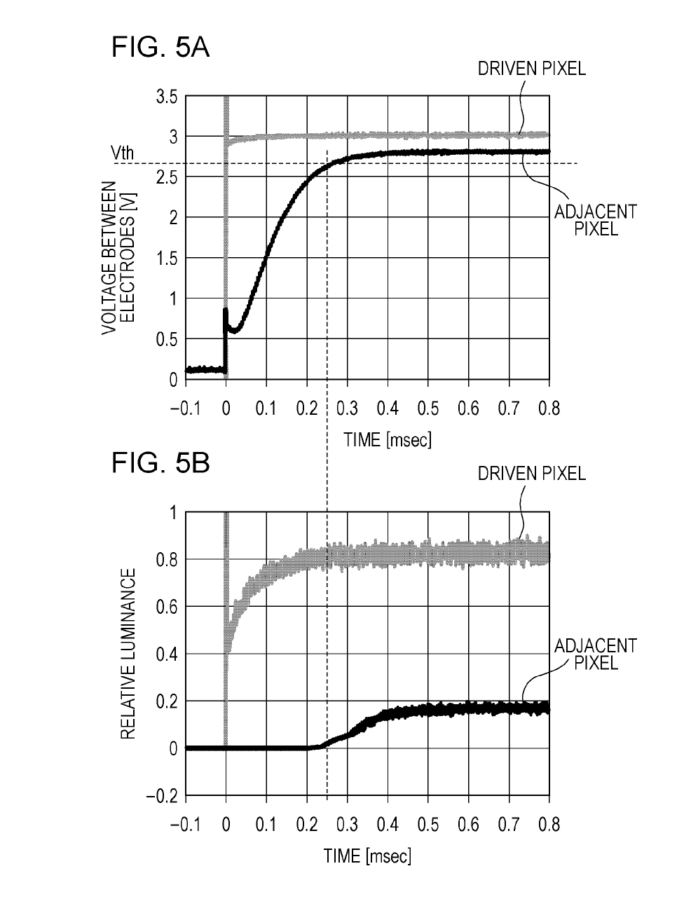

FIG. 5A shows time responses of the voltages of a target pixel to which a current is supplied in order to cause light to be emitted (hereinafter referred to as “driven pixel”) and an adjacent pixel when a voltage of 3 V was applied between a first electrode and a second electrode of the driven pixel. FIG. 5B shows time responses of the luminance. The connection between a drive circuit of the adjacent pixel and a power supply is disconnected, and the drive circuit of the adjacent pixel is in an open state.

After a current is started to supply to the driven pixel at a time of 0, the voltage of the driven pixel rises without retardation. After the start of the current supply, the voltage of the adjacent pixel gradually increases and reaches a steady-state value of 2.7 V after a time of 0.3 to 0.4 ms. During this period, a leakage current flowing between the pixels first charges the parasitic capacitance C of the adjacent pixel. The adjacent pixel does not emit light until the voltage of the parasitic capacitance C reaches a light emission threshold voltage Vₜₕ. When the voltage of the parasitic capacitance C exceeds the light emission threshold voltage, part of the leakage current flows in the organic EL element of the adjacent pixel, thus starting light emission.

The adjacent pixel starts to emit light after the voltage between the electrodes exceeds the light emission threshold voltage. Therefore, the retardation shown in FIG. 5B is caused to occur from the start of the light emission from the driven pixel to the start of the light emission from the adjacent pixel. The time constant of the retardation is given by the product of Rb and C.

Accordingly, after a current corresponding to a light-emission luminance is supplied to the driven pixel and before the voltage of the adjacent pixel in the turned-off state reaches the light emission threshold voltage, the voltage of the driven pixel is decreased to the light emission threshold voltage or less, whereby light emission from the adjacent pixel can be suppressed. In other words, the driven pixel is driven so as to be switched between emitting light and being turned off, and the duration of light emission at one time is set such that a variation range of the voltage of the adjacent pixel is equal to or less than the light emission threshold voltage.

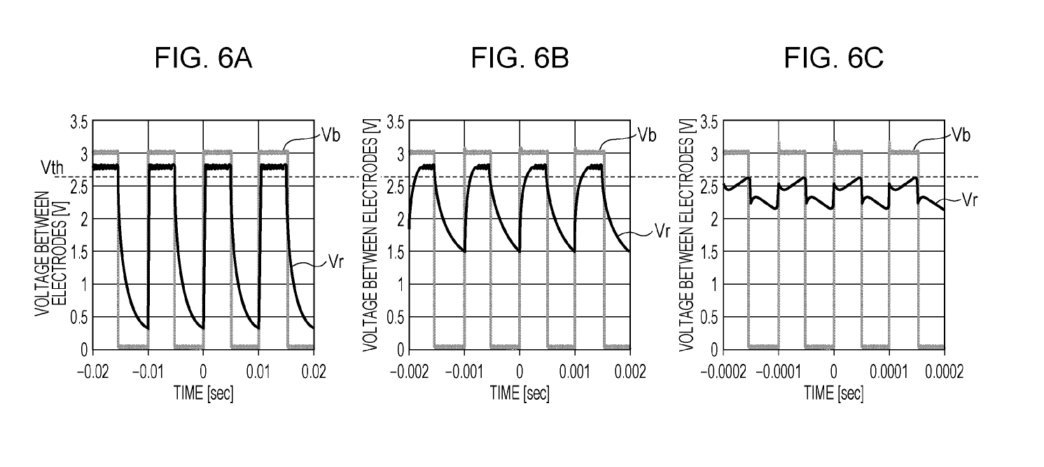

FIGS. 6A, 6B, and 6C show a change in the voltage between the first electrode 2 and the second electrode 5 with time when the frequency of an alternating voltage is set to 100 Hz, 1 kHz, and 10 kHz, respectively. FIGS. 6A to 6C show the results obtained when the voltage Vr between the first electrode and the second electrode of the adjacent pixel was measured while an alternating rectangular-wave voltage of 3 V and 0 V was applied to a driven pixel. The first electrode 2 of the driven pixel is connected to a constant voltage power supply of 3 V, and nothing is connected to the first electrode of the adjacent pixel. In this state, the alternating rectangular-wave voltage of 0 V and 3 V was applied to the second electrode. The duty of the alternating voltage was 50%.

(a) At a frequency of 100 Hz, the voltage Vr of the adjacent pixel reaches a steady-state value of 2.8 V and exceeds the threshold voltage Vₜₕ of 2.6 V. It is believed that the adjacent pixel emits light during the time when the voltage Vr exceeds the threshold voltage.

(b) At a frequency of 1 kHz, the voltage Vr of the adjacent pixel reaches 2.8 V. However, the proportion of the time during which the voltage Vr of the adjacent pixel exceeds the threshold voltage Vₜₕ of 2.6 V is lower than that in the case of (a). Thus, the luminance of the adjacent pixel is lower than that in the case of (a).

(c) At a frequency of 10 kHz, the voltage Vb of the driven pixel becomes 0 V immediately before the voltage Vr of the adjacent pixel reaches the threshold voltage, and thus the voltage Vr of the adjacent pixel cannot reach the threshold voltage. In this case, light emission from the adjacent pixel does not occur. Only light emitted from the driven pixel is output and light emission due to the leakage current from the driven pixel to the adjacent pixel does not occur. Thus, blue light emission with high purity can be obtained.

As described above, the voltage response of the adjacent pixel is temporally delayed as compared with the voltage of the driven pixel. After a current is supplied to the driven pixel, the voltage of the adjacent pixel starts to increase at a time constant of RbC. Immediately before the voltage of the adjacent pixel reaches the threshold voltage, the voltage of the driven pixel is decreased to the light emission threshold value or less to stop the light emission. Thus, the light emission from the adjacent pixel during the light emission from the driven pixel can be suppressed. The time during which a current is supplied to the driven pixel at one time is set so as to be shorter than the time during which a variation in the voltage of the adjacent pixel reaches the threshold voltage. The voltage of the adjacent pixel also decreases while the voltage of the driven pixel is decreased to the light emission threshold voltage or less. After the voltage of the adjacent pixel sufficiently decreases, a current is again supplied to the driven pixel to cause light emission. The voltage of the adjacent pixel again increases, and thus the voltage of the driven pixel is again decreased to the light emission threshold voltage or less before the voltage of the adjacent pixel reaches the threshold voltage.

A drive current is intermittently provided to the driven pixel in this manner, thereby causing light emission intermittently. By adjusting the magnitude of the intermittent drive current, the frequency, and the duty, the luminance of the pixel to be driven can be controlled to a desired value and light emission from the adjacent pixel can be suppressed.

When the light emission from the driven pixel is stopped, the voltage of the driven pixel is not necessarily decreased to 0 V. It is sufficient that the voltage is equal to or less than the light emission threshold voltage of the organic EL element.

If the voltage at the time of stopping the light emission from the driven pixel is equal to or higher than the light emission threshold voltage, the voltage of the adjacent pixel reaches the light emission threshold voltage or higher while repeating the intermittent supply of the current. Consequently, light emission due to the leakage current occurs.

A drive circuit for intermittently causing a pixel to emit light and causing the pixel to turn off and a driving method using the drive circuit will be described in detail in exemplary embodiments described below. An outline of the drive circuit and the driving method is as follows.

The drive circuit switches between a period during which a current corresponding to a luminance of each pixel is supplied to a plurality of pixels and a period during which a voltage equal to or less than a threshold value is supplied to all the pixels simultaneously. As a result, each of the pixels is periodically switched between light emission and non-light emission.

During the light emission period, the drive circuit functions as a current source that generates and outputs an independent current for each pixel. The drive circuit supplies a large current to a pixel that emits light at a high luminance, a small current to a pixel that emits light at a low luminance, and a current of zero to a pixel that is turned off. In the case where a pixel takes two states of light emission and non-light emission, a voltage source that is common to all the pixels may be used and a switch may be provided for each pixel so as to select whether the voltage source is connected or disconnected to the first electrode.

On the other hand, during the period during which the current supply is stopped and the voltage decreases to the light emission threshold value or less, the drive circuit is switched to a voltage source that supplies a voltage equal to or less than the threshold value between the first electrode and the second electrode. It is necessary that the drive circuit during this period function as a voltage source that forcibly controls the voltage of a pixel to the threshold value or less. If a current source circuit that supplies a current of zero is connected to the pixel rather than the voltage source, the voltage between the first electrode and the second electrode decreases to the light emission threshold voltage but does not decrease to a value less than the threshold voltage. At this time, the voltage response of the adjacent pixel is temporally delayed as compared with a change in the voltage of the driven pixel. Accordingly, when the supply and stopping of the current to the driven pixel are repeatedly performed, the voltage of the adjacent pixel gradually increases and exceeds the light emission threshold value.

As described above, during the current supply period, the drive circuit functions as a current source that generates a current corresponding to the luminance, and during the current-stopping period, the drive circuit functions as a voltage source that outputs a voltage equal to or less than the light emission threshold value.

The current source is a circuit whose output impedance is considered to be substantially infinite, and the voltage between the first electrode and the second electrode of each pixel is determined by the current flowing in the organic EL element. The voltage of a pixel that emits light at a high luminance is determined by the current flowing in the organic EL element of the pixel. However, when a pixel that emits light at a low luminance or a pixel in a turned-off state is disposed adjacent thereto, a leakage current flows from the pixel that emits light at a high luminance through the resistance between the pixels. The voltage between the first electrode and the second electrode of the pixel that emits light at a low luminance is determined by the leakage current. In contrast, the drive circuit during the non-light emission period functions as a voltage source whose output impedance is substantially zero, whereby the voltage of all the pixels is forcibly controlled to a value equal to or less than the threshold value.

The light emission and the non-light emission are periodically switched. The duration of the light emission and the timing at which the light emission is stopped can be set by adjusting the frequency or by adjusting the duty.

When light emission from one pixel is started in one period, the voltage of an adjacent pixel in a turned-off state starts to increase by a leakage current. Before this voltage exceeds the light emission threshold value, the voltage of the one pixel is decreased to stop the light emission.

The driven pixel may be driven by an alternating voltage in a high-frequency band in which the voltage of the adjacent pixel does not reach the threshold voltage. Alternatively, the driven pixel may be driven by an alternating voltage which has a small duty but a low frequency. In any of these cases, the voltage of the adjacent pixel can be controlled so as not to reach the threshold voltage.

In a matrix display device in which the first electrodes are arranged in a matrix, a selection signal is sequentially applied to scanning lines for each row, the scanning lines being provided in the row direction. Data signals of data lines provided in the column direction are written into pixel circuits arranged in a row to which the selection signal has been applied.

Image data is periodically transmitted, and a luminance signal of each pixel is rewritten in accordance with the image data. The time from the writing of a luminance signal into a pixel to the writing of the next luminance signal into the pixel is defined as a 1 frame period. The supply and stopping of a drive current are repeated a plurality of times during the 1 frame period to make the frequency thereof high. Thus, the voltage of an adjacent pixel becomes the threshold value or less.

In the case where the response time constant of the adjacent pixel is substantially the same as or longer than the 1 frame period, turning-on and turning-off may each be conducted once during the 1 frame period. This operation can also suppress light emission from the adjacent pixel.

In the case where the time from when an image signal at a maximum luminance is written into a pixel to start light emission until the voltage response of a pixel in a turned-off state reaches the light emission threshold voltage is ⅓ of the 1 frame period, the light emission is stopped at the time when a time corresponding to the ⅓ frame period has passed, and the pixel is made to enter a turned-off state during the remaining ⅔ frame period. In this case, alternating-voltage driving is performed at the same frequency as the frame frequency and at a duty of 33%.

In the case where the time from when an image signal at a maximum luminance is written into a pixel to start light emission until the voltage response of a pixel in a turned-off state reaches the light emission threshold voltage is ¼ of the 1 frame period, the light emission is stopped at the time when a time corresponding to the ¼ frame period has passed, light emission is resumed at the time when a time corresponding to the 2/4 frame period has passed, and the light emission is again stopped at the time when a time corresponding to the ¾ frame period has passed. In this case, alternating-voltage driving is performed at a frequency two times the frame frequency and at a duty of 50%.

In the case where the response time constant of the adjacent pixel is substantially the same as or shorter than the period during which a selection signal is applied to one row, turning-on and turning-off are repeated in synchronization with the selection signal. Turning-on and turning-off are each performed once or alternately repeated a plurality of times during the period during which a selection signal is applied to one row.

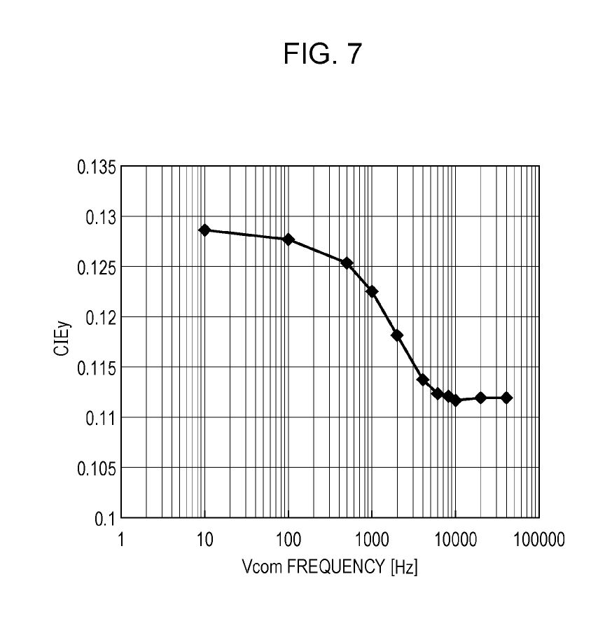

FIG. 7 shows the degree of a color shift due to a leakage current of red and green organic EL elements when a blue organic EL element is caused to emit light, as a change with respect to the frequency of alternating-voltage driving. The axis of abscissa represents the frequency of an alternating voltage. The axis of ordinate represents a CIEy value of synthesized light. The voltage Vb is 3 V.

When the frequency is higher than 10 kHz, no leakage current is generated, and a blue having a constant CIEy value and a high color purity is obtained. When the frequency is lower than 10 kHz, not only the blue organic EL element but also the adjacent red and green organic EL elements emit light, and thus the CIEy value is shifted from that of a pure blue.

In the above description, the supply of a drive current and the application of a voltage equal to or less than the threshold value are performed in the form of a rectangular wave. However, the present disclosure is not limited thereto. It is sufficient that the voltage of the driven pixel is set to decrease to the threshold voltage or less before the voltage of an adjacent pixel exceeds the threshold value. The drive current may be a triangular wave or a sine wave.

The maximum of the drive current is set in accordance with the luminance of a driven pixel. When a current that causes the driven pixel to be in a light emission state is supplied, the voltage between the electrodes becomes equal to or higher than the light emission threshold value. During the period during which a voltage is applied, the voltage between the electrodes is set to a voltage equal to or less than the threshold value. Accordingly, an alternating voltage that is equal to, more than, or less than the light emission threshold voltage of an organic EL element appears between the first electrode and the second electrode of the driven pixel.

In the measurement shown in FIG. 5, an alternating voltage is applied to the second electrode side. Alternatively, an alternating voltage may be applied from the first electrode.

During the period during which an organic EL element is current-driven, the drive circuit functions as a current source. When the drive circuit controls the supply of the current to zero, a driven pixel is changed to a turned-off state. The drive circuit controls the current supplied to the first electrode to a finite value or zero in accordance with the luminance of the pixel.

During the period during which an organic EL element is voltage-driven, the output is switched from a current source to a voltage source with a switch of the drive circuit. Alternatively, as described in the first exemplary embodiment below, the current of the drive circuit is stopped by making the voltage of a common power supply connected to the second electrode closer to the electric potential of the first electrode, preferably, equal to the electric potential of the power supply of the drive circuit. Alternatively, as described in the second exemplary embodiment below, the current can be cut off by lowering a power supply voltage V_{oled} of the drive circuit, that is, by making the electric potential of the power supply closer to an electric potential V_{com} of the second electrode of the organic EL element.

The amplitude, the frequency, and the duty of the actual alternating voltage or alternating current are adjusted in accordance with the guideline described below on the assumption that the driven pixel reaches a predetermined luminance on the time average.

(A) In the case where the voltage of an adjacent pixel can be measured, the frequency of alternating-current/voltage driving is increased or the duty thereof is decreased such that the voltage of the adjacent pixel does not exceed the threshold voltage Vₜₕ.

(B) In the case where a light-emitting device includes pixels that emit light of red, green, and blue (RGB) and the chromaticity of the colors can be measured, the frequency of alternating-current/voltage driving is increased or the duty thereof is decreased such that the color purity is sufficiently high when each of red, green, and blue light is emitted in monochrome.

(C) In the case where the luminance of a pixel unit can be measured, the frequency of alternating-current/voltage driving is increased or the duty thereof is decreased such that the luminance of an adjacent pixel is lower than a standard value of the luminance in the darkest state.

The above (A) to (C) can also be used as a determination method for determining whether or not light emission due to a leakage current occurs. Even in the case where the pixel resistance Ra and the resistance Rb between pixels of an organic EL element cannot be measured, when any of the voltage, the chromaticity, and the luminance can be measured, it is possible to determine whether or not light emission due to a leakage current occurs in the organic EL element.

### Materials of Organic EL Element and Method for Producing Light-Emitting Device

Materials of an organic EL element and a method for procuring a light-emitting device will now be described.

Examples of the material of the substrate 1 include quartz, glass, a silicon wafer, resins, and metals. A switching element such as a thin-film transistor, and wiring are formed on the substrate 1.

In the case where the first electrode 2 is a reflective electrode, chromium, aluminum, silver, titanium, an alloy thereof, a laminate thereof, or the like is used. In the case where the first electrode 2 is used as a transparent electrode, a metal oxide such as indium tin oxide (ITO) or indium zinc oxide (IZO) is used.

Known materials can be used as the charge transport layer 3. When the first electrode 2 is an anode, a triphenyldiamine derivative, an oxadiazole derivative, a porphyrin derivative, a stilbene derivative, or the like can be used as a hole transport layer.

A hole injection layer and a hole transport layer may be stacked so that a plurality of layers function as a hole transport layer. Examples of the material of the hole injection layer include oxides such as molybdenum oxide and tungsten oxide, and organic substances such as 2,3,5,6-tetrafluoro-7,7,8,8-tetracyanoquinodimethane (F4TCNQ). Alternatively, the hole injection layer may be a mixed layer including a layer composed of any of these materials and a hole transport layer. In particular, when a material such as F4TCNQ is used in combination with a hole transport layer, a hole injection/transport layer having a low resistance can be formed and a drive voltage can be reduced. The hole transport layer is common to respective pixels, and provided so as to extend over the pixels. However, in order to increase the light-extraction efficiency by using interference, the thickness of the hole transport layer may be changed for each pixel depending on the color.

Known light-emitting materials can be used as the light-emitting layer 4. Examples thereof include materials that function as an organic light-emitting layer when being used alone, and mixed materials obtained by mixing a light-emitting material with a light-emitting dopant, a charge transport dopant, a light-emitting auxiliary dopant, or the like. In a single-color light-emitting device, a single light-emitting material is used. In a color light-emitting device, different materials are used depending on the color.

The light-emitting layer 4 in the present disclosure may be a single layer. Alternatively, another layer may be stacked on the second electrode side of the light-emitting layer 4. For example, in the case where the second electrode 5 is a cathode, an electron transport layer, an electron injection layer, or the like may further be provided.

Known materials can be suitably used as the electron transport layer. Examples thereof include aluminum-quinolinol derivatives, oxadiazole derivatives, triazole derivatives, phenylquinoxaline derivatives, silole derivatives, and phenanthroline derivatives.

An electron injection layer and an electron transport layer may be stacked so that a plurality of layers function as an electron transport layer. As the electron injection layer, a mixture of an electron-donating dopant and an electron transport material is used. Examples of the electron-donating dopant include alkali metals, alkaline earth metals, rare-earth metals, and compounds thereof.

The electron injection layer is formed by incorporating 0.1% to several tens of percent of an alkali metal compound in an electron transport material. Preferably, the alkali metal compound is a cesium compound. More preferably, the cesium compound includes cesium carbonate and a substance derived from cesium carbonate.

The electron injection layer is formed by co-deposition of cesium carbonate and an electron transport material. In order to ensure a good electron-injecting property, the electron injection layer has a thickness of 10 to 100 nm. Suboxides such as (Cs₁₁O₃)Cs₁₀, (Cs₁₁O₃)Cs, and Cs₁₁O₃, all of which are derived from cesium carbonate, may be formed in the electron injection layer by, for example, decomposition of cesium carbonate during co-deposition. In addition, a coordination compound may be formed between cesium and an organic compound.

In the case of a top-emission element, a transparent electrode composed of ITO or the like is used as the second electrode 5. A bottom-emission element may be produced by using an opaque electrode composed of aluminum (Al) or the like.

The sealing film 6 is formed after the formation of the second electrode 5. A passivation film composed of SiN or the like is formed as the sealing film 6 on the second electrode 5 to suppress infiltration of water etc. into the organic compound layers. In another embodiment, glass provided with a moisture absorbent may be bonded on the second electrode 5.

In order to provide the color filters 7, 8, and 9, color filter substrates whose size is adjusted to a pixel size are bonded to each other, or a color filter is patterned on the sealing film 6 composed of SiN or the like.

Specific exemplary embodiments of the present disclosure will now be described.

### First Exemplary Embodiment

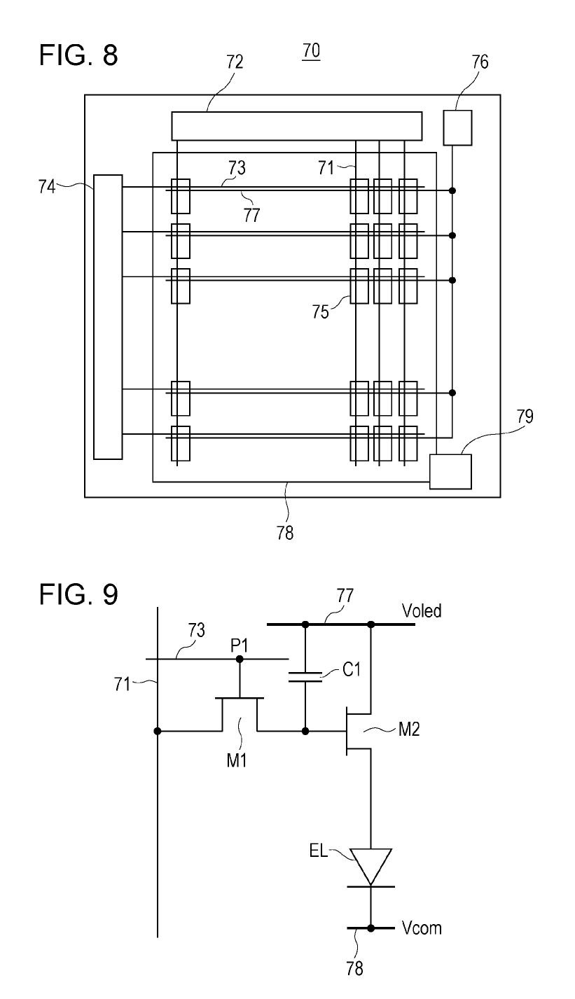

FIG. 8 is a schematic view illustrating a structure of a matrix display device including a light-emitting device 70.

The light-emitting device 70 includes information lines 71, an information line-driving circuit 72 that applies an information voltage to the information lines 71, scanning lines 73, a scanning line-driving circuit 74 that drives the scanning lines 73, organic EL elements (not shown) arranged at intersecting portions of the information lines 71 and the scanning lines 73, pixel circuits 75 that control the current supplied to the organic EL elements, a power supply 76 that provides a voltage V_{oled} to the pixel circuits 75, power supply lines 77 extending from the power supply 76, a common electrode 78 that connects second electrodes of the organic EL elements to each other, and a common power supply 79 that provides a voltage V_{com} to the common electrode 78. The matrix display device includes, in addition to the light-emitting device 70, a control circuit (not shown) that provides a control signal to the information line-driving circuit 72, the scanning line-driving circuit 74, the power supply 76, and the common power supply 79 to control these circuits and power supplies. The pixel circuits 75 are the same as the pixel circuits 24, 25, and 26 illustrated in FIG. 2. The power supply lines 77 supply the voltage V_{oled} to all the pixel circuits 75. The common electrode 78 is a planar electrode provided over the rectangular region in FIG. 8. The number of the scanning lines 73 is 480, and the number of the information lines 71 is 1,920 (=640 lines×RGB).

In each of the organic EL elements, an interlayer insulating film is provided between a substrate 1 and first electrode 2, an electron-blocking layer is provided between a charge transport layer 3 and a light-emitting layer 4, and furthermore, another charge transport layer is provided on the light-emitting layer 4. The charge transport layer 3 is constituted by a hole injection layer and a hole transport layer. The other charge transport layer is constituted by an electron injection layer and an electron transport layer. Other structures are the same as those of the light-emitting device illustrated in FIG. 1.

Pixel circuits are formed on a substrate 1, and an interlayer insulating film composed of SiO is formed thereon. A titanium (Ti) film is formed on the substrate 1 by a sputtering method so as to have a thickness of 50 nm. Subsequently, the Ti film is patterned for each pixel to form first electrodes 2. The shape and the dimensions of the first electrodes 2, and the gap between the pixels are the same as those illustrated in FIG. 3.

A hole injection layer and a hole transport layer are formed on the first electrodes 2. As the hole injection layer, a film that is composed of a hole transport material represented by Chemical Formula 1 below and doped with 0.5% by weight of NDP9 (manufactured by NOVALED AG.) is deposited so as to have a thickness of 15 nm. The hole transport layer is formed by depositing the hole transport material represented by Chemical Formula 1 so as to have a thickness of 10 nm.

As an electron-blocking layer, a material represented by Chemical Formula 2 is deposited on the hole transport layer so as to have a thickness of 10 nm.

As a light-emitting layer 4 that emits white light, a film composed of a material represented by Chemical Formula 3 and doped with 2% by weight of a light-emitting dopant represented by Chemical Formula 4 and 0.2% by weight of TRR-D125 (manufactured by Toray Industries, Inc.) is deposited on the electron-blocking layer so as to have a thickness of 10 nm. Subsequently, a film composed of the material represented by Chemical Formula 3 and doped with 1% by weight of a light-emitting dopant represented by Chemical Formula 5 is formed so as to have a thickness of 10 nm.

Furthermore, as an electron transport layer, a material represented by Chemical Formula 6 is deposited so as to have a thickness of 10 nm. An electron injection layer is then formed by co-depositing the material represented by Chemical Formula 6 and Cs₂CO₃ so that the cesium concentration in the electron injection layer is 8.3% by weight.

A second electrode 5 is formed on the electron injection layer. The second electrode 5 is formed by depositing a metal oxide (IZO) so as to have a thickness of 500 nm.

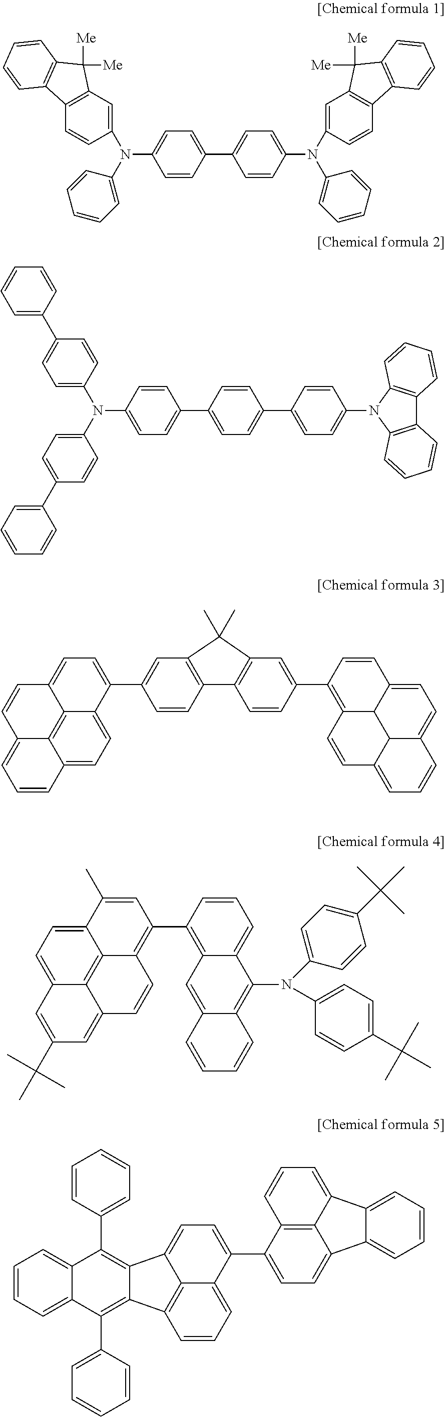

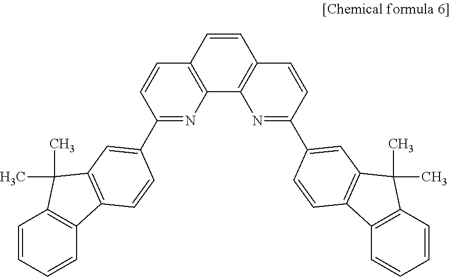 [SMILES: CC1(C)c2ccccc2-c2ccc(-c3ccc4ccc5ccc(-c6ccc7c(c6)C(C)(C)c6ccccc6-7)nc5c4n3)cc21]

The organic compound layers and the second electrode 5, all of which are disposed on the first electrodes 2, are not patterned for each pixel, and are common to all the pixels. A passivation film 6 composed of SiN is deposited on the second electrode 5 so as to have a thickness of 2 μm. Color filters 7, 8, and 9 in which a pigment is dispersed in a negative acrylic photosensitive material are formed on the passivation film 6 for each pixel by photolithography.

FIG. 9 is a circuit diagram illustrating a pixel circuit 75 and an organic EL element connected to the pixel circuit 75.

A scanning line 73 is connected to a gate of a transistor M1. A voltage data V_{data} is input from an information line 71 and is stored in a storage capacitor C1 through the transistor M1. A transistor M2 is connected in series between a power supply V_{oled} and a first electrode (anode) of an organic EL element. The transistor M2 is a drive transistor that generates a current in accordance with the voltage of the storage capacitor C1 and supplies the current to the organic EL element. The drive transistor M2 is a P-type MOS transistor. A source of the drive transistor M2 receives a power supply voltage V_{oled} from a power supply 76 through a power supply line 77. A drain of the drive transistor M2 is connected to the first electrode (anode) of the organic EL element. A second electrode (cathode) of the organic EL element is connected to a common power supply 79 through a common electrode 78 and receives a voltage V_{com}.

The pixel circuit 75 adjusts the current supplied to the organic EL element with the drive transistor M2. A drive current corresponding to the luminance is supplied to a pixel that is to be caused to emit light, and no current is supplied to a pixel that is not to emit light.

In this exemplary embodiment, the common power supply 79 outputs an alternating voltage of V_{com}=0V/3V to provide the alternating voltage to the second electrode. When V_{com}=0V, a drive current corresponding the voltage between the source and the gate of the drive transistor M2 is supplied to the organic EL element. When V_{com}=3V, the drive transistor M2 turns to the on-state in a reverse direction and discharges charge accumulated in the parasitic capacitance of the organic EL element so that the source and the drain have the same electric potential (=3 V). The transistor M2 operates as a switch in a linear region, and thus a voltage of 0 V is applied between the electrodes of the organic EL element. This is a voltage lower than the light emission threshold value. Thus, the organic EL element stops the light emission.

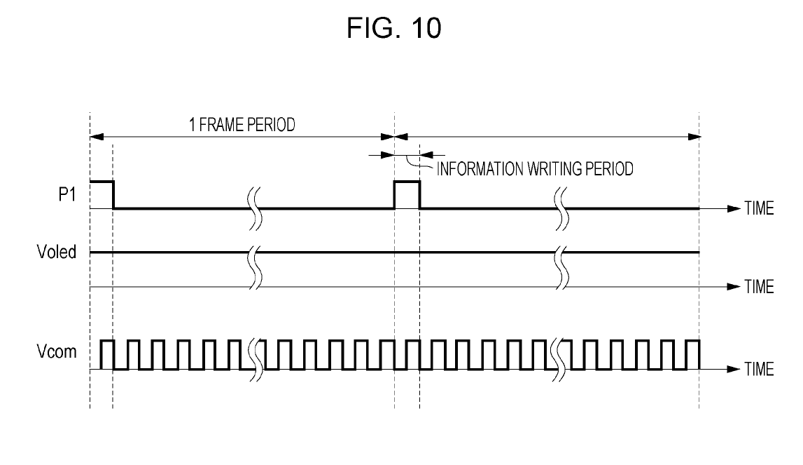

FIG. 10 is a timing chart illustrating an operation of the pixel circuit 75 in FIG. 9. FIG. 10 illustrates the charts of a scanning signal P1 of the scanning line 73, the output voltage V_{oled} of the power supply 76, and the output voltage V_{com} of the common power supply 79.

At the timing when the scanning signal P1 becomes HI, an information signal V_{data} is written into the capacitor C1. Subsequently, the drive transistor M2 generates a drive current in accordance with the V_{data} stored in the capacitor C1.

The V_{oled} is a constant voltage (3 V) and the V_{com} is an alternating voltage (rectangular wave of 0 V/3 V). When V_{com}=0 V, a current is supplied from the pixel circuit and the organic EL element emits light or is turned off in accordance with the value of the current. When V_{com}=3 V, no drive current flows in the pixel, and the light emission is stopped.

One frame (vertical synchronization signal) is 60 Hz and a horizontal synchronization signal is 28.8 kHz (=60×the number of scanning lines 480). The frequency of the V_{com} is 28.8 kHz (synchronized with the horizontal synchronization signal).

The organic EL element repeats light emission and stopping of the light emission at 28.8 kHz except for the writing period. The light emission time and the turned-off time at one time are each 17 μs.

The frequency of the V_{com} is preferably the same as the horizontal synchronization signal or a multiplication thereof. When the frequency of the V_{com} is a multiplication of the horizontal synchronization signal, the timings of the scanning signal P1, the information signal V_{data}, and the common power supply voltage V_{com} during the data writing are the same in all the pixels, and uniform writing is performed.

In the light-emitting device of the first exemplary embodiment in which the V_{com} was applied as an alternating voltage, the color purity that can be output by each of red, green, and blue was improved as compared with the case where the V_{com} was fixed to a constant electric potential.

### Second Exemplary Embodiment

In the first exemplary embodiment, an alternating voltage is applied to the second electrode which is a common electrode. This exemplary embodiment is an example of a display device in which an alternating voltage is supplied from the first electrode.

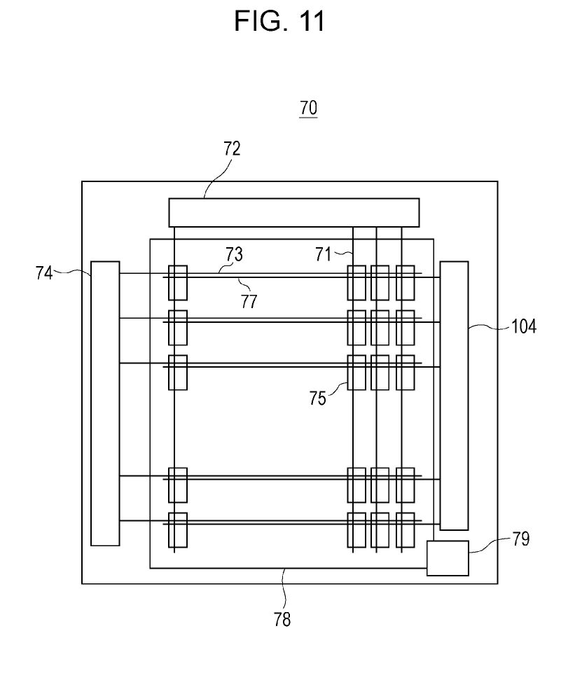

FIG. 11 is a schematic view of a light-emitting device. Parts common to those in the first exemplary embodiment are assigned the same reference numerals. The matrix display device include, in addition to a light-emitting device 70, a control circuit (not shown) that provides a control signal to an information line-driving circuit 72, a scanning line-driving circuit 74, a power supply line-driving circuit 104, and a common power supply 79 to control these circuits and the power supplies.

The second exemplary embodiment differs from the first exemplary embodiment in that power supply lines 77 that are independent for each row are arranged so as to be parallel with scanning lines 73. The power supply line-driving circuit 104 that drives the power supply lines 77 in units of row is provided instead of the power supply 76 in the first exemplary embodiment. Organic EL elements and pixel circuits the same as those used in the first exemplary embodiment are used in the second exemplary embodiment.

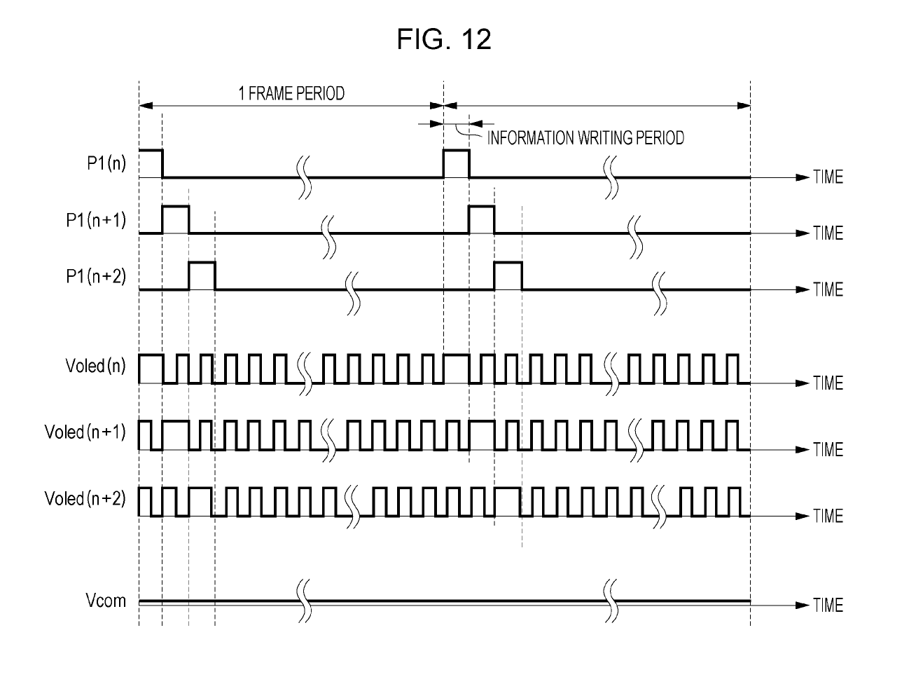

FIG. 12 is a timing chart illustrating an operation of the light-emitting device of the second exemplary embodiment. FIG. 12 illustrates the charts of scanning signals P1(n), P1(n+1), and P1(n+2) of the scanning lines 73 in the nth row, the (n+1)th row, and the (n+2)th row, voltages V_{oled}(n), V_{oled}(n+1), and V_{oled}(n+2) of the power supply lines 77 in the nth row, the (n+1)th row, and the (n+2)th row, and the voltage V_{com} of the common power supply 79. At the timing when the scanning signal P1 in the nth row becomes HI, an information signal V_{data} is written into the capacitor C1 of each of the pixel circuits 75 in the nth row. A transistor M2 generates a current in accordance with the V_{data}. The V_{com} is a fixed voltage (0 V).

The power supply line-driving circuit 104 outputs, to the power supply lines 77 of respective rows, a voltage V_{oled} at a shifted timing. Specifically, during the writing period, the power supply line-driving circuit 104 outputs a constant voltage of 3 V, and except for during the writing period, the power supply line-driving circuit 104 outputs a rectangular wave voltage of 0 V/3 V. During the period during which the scanning signal P1(n) is at a high level, a V_{oled}(n) of 3 V is applied. During the period during which the scanning signal P1(n) is at a low level, a V_{oled}(n) of a rectangular wave alternating voltage of 3 V/0 V at 10 kHz at a duty of 50% is output.

The information signal is written at V_{oled}=3 V for each row. After the writing is completed, when V_{oled}(n)=3 V, the pixel circuit 75 outputs a drive current to an organic EL element. Each organic EL element emits light in accordance with the current. When V_{oled}(n)=0 V, the V_{oled} is equal to the V_{com}. Thus, the pixel circuit 75 cannot generate a drive current. Since no current is supplied to each organic EL element, all the organic EL elements do not emit light.

The output of the power supply line-driving circuit 104 is synchronized with the scanning signal P1(n). The voltage V_{oled} of the power supply line 77 does not necessarily have a single frequency as long as the voltage V_{oled}(n) of the power supply line 77 is synchronized with the scanning signal P1(n).

Also in the light-emitting device of the second exemplary embodiment in which the voltage V_{oled}(n) of the power supply line 77 was applied as an alternating voltage, the color purity was improved as compared with the case where the V_{oled} was fixed to a constant electric potential. Regarding the chromaticity of blue, an improvement shown in FIG. 7 was obtained. With an increase in the frequency, the CIEy value decreases, which indicates that blue light emission with a high color purity occurs. Regarding the chromaticity of green and red, the same results were obtained.

### Third Exemplary Embodiment

A light-emitting device can be used as an exposure light source of an image forming apparatus such as an electrophotographic printer. The image forming apparatus includes a light-emitting device, and a photoconductor in which a latent image is formed on a surface thereof by the light-emitting device.

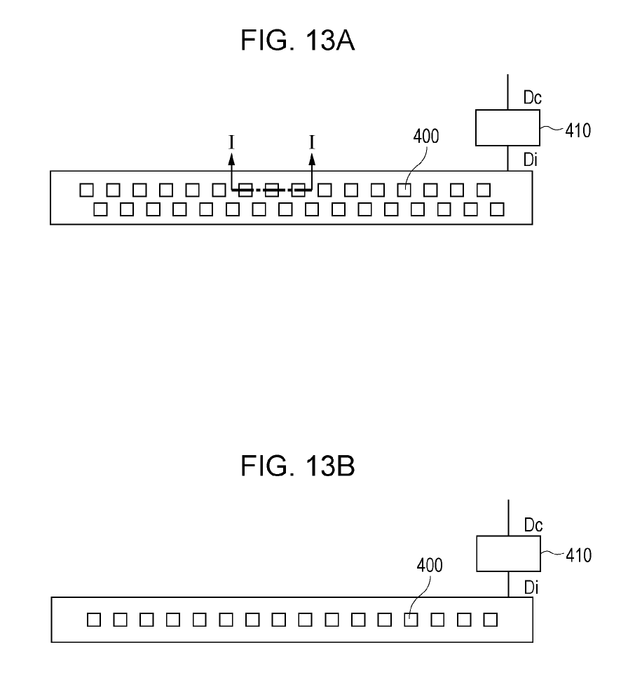

FIGS. 13A and 13B are each a view illustrating a planar array of organic EL elements in a light-emitting device of a third exemplary embodiment. The light-emitting device of this exemplary embodiment includes a plurality of light-emitting regions 400 formed by the organic EL elements. FIG. 13A illustrates an example in which the light-emitting regions 400 are arrayed in a zigzag manner, and FIG. 13B illustrates an example in which light-emitting regions 400 are linearly arrayed. A cross section of organic EL elements taken along line I-I of FIG. 13A has the same layer structure as that illustrated in FIG. 1. The light-emitting regions 400 are defined by the first electrodes 2 in FIG. 1. However, the organic EL elements of this exemplary embodiment do not include the color filters 7 to 9 in FIG. 1.

An emission spectrum of an organic EL element is appropriately determined in accordance with photosensitive characteristics of the photoreceptor.

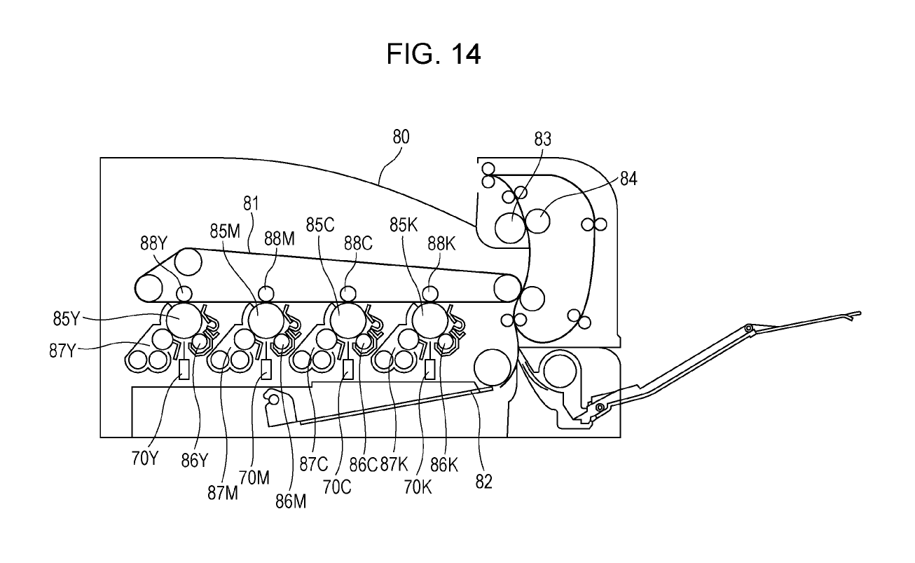

FIG. 14 is a schematic view illustrating a structure of an image forming apparatus including a light-emitting device of this exemplary embodiment as an exposure light source, and illustrates a cross section along an auxiliary scanning direction.

The image forming apparatus can selectively carry out a color mode in which a color image is formed by overlapping four color toners of yellow (Y), magenta (M), cyan (C), and black (K) and a monochrome mode in which a monochrome image is formed by using only a toner of black (K). When code data Dc is input from external equipment such as a personal computer to a print controller 410, the code data Dc is converted to image data (dot data) Di. The image data Di is input to exposure units 70Y, 70M, 70C, and 70K installed in the image forming apparatus. The exposure units 70Y, 70M, 70C, and 70K are each controlled on the basis of the image data Di.

The exposure unit 70Y includes a light-emitting device of this exemplary embodiment and a lens that collects light emitted from the light-emitting device and applies exposure light onto a surface of a photoconductive drum 85Y. The exposure unit 70Y may include a light absorption member so that a portion other than a predetermined position of the surface of the photoconductive drum 85Y is not irradiated with light.

In a housing 80 of the image forming apparatus, in addition to the exposure units 70Y, 70M, 70C, and 70K, a transfer belt 81, a paper feed unit 82, a fixing roller 83, and a pressure roller 84 are arranged. Furthermore, photoconductive drums 85Y, 85M, 85C, and 85K, charging rollers 86Y, 86M, 86C, and 86K, developing units 87Y, 87M, 87C, and 87K, and transfer rollers 88Y, 88M, 88C, and 88K are arranged in the housing 80. The paper feed unit 82 is detachably attached.

An image forming operation is as follows. A description will be made of a case where a latent image of a yellow (Y) image is formed. A sheet is transported by the transfer belt 81, and images of magenta (M), cyan (C), and black (K) are sequentially formed as in the formation of the yellow (Y) image.

First, the photoconductive drum 85Y, which is an electrostatic latent image-carrying member, is rotated in the clockwise direction by a motor (not shown) on the basis of a signal from the print controller. With this rotation, a photoconductive surface of the photoconductive drum 85Y is rotated with respect to the exposure light. The charging roller 86Y for charging the surface of the photoconductive drum 85Y with a desired pattern is provided on an upper part of the photoconductive drum 85Y so as to be in contract with the surface. The surface of the photoconductive drum 85Y that has been uniformly charged by the charging roller 86Y is irradiated with the exposure light by the exposure unit 70Y.

The irradiation spot, the irradiation timing, the irradiation time, the irradiation intensity etc., of the exposure light emitted from the exposure unit 70Y are adjusted on the basis of the image data Di, and a latent image is formed on the surface of the photoconductive drum 85Y by the exposure light. This latent image is developed as a toner image by the developing unit 87Y, which is provided to be in contact with the photoconductive drum 85Y on the downstream side of the rotation direction of the photoconductive drum 85Y with respect to the irradiation spot of the exposure light.

The toner image developed by the developing unit 87Y is transferred to a sheet, which is a material to be transferred, by the transfer roller 88Y arranged so as to face the photoconductive drum 85Y on a lower part of the photoconductive drum 85Y. The sheets are stored in a sheet cassette in the paper feed unit 82. Alternatively, the sheets can be fed from a manual feed tray. A paper feed roller is provided at an edge of the sheet cassette so as to feed a sheet in the sheet cassette to a transportation path.

The sheet to which the toner image is transferred as described above is transported to a fixing unit by the transfer belt 81. The fixing unit includes the fixing roller 83 having a fixing heater (not shown) therein, and the pressure roller 84 arranged so as to be in contact with the fixing roller 83 under pressure. The transported sheet is heated while applying a pressure with the fixing roller 83 and the pressure roller 84, thereby fixing the toner image on the sheet.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2012-176007, filed Aug. 8, 2012, which is hereby incorporated by reference herein in its entirety.

What is claimed is:

1. A light-emitting device comprising:
a plurality of organic EL elements including
a plurality of first electrodes arranged on a substrate separately from each other with gaps therebetween,
a second electrode disposed over the first electrodes, and
organic compound layers disposed between each of the first electrodes and the second electrode; and
a drive circuit for driving the organic EL elements,
wherein
at least a part of the organic compound layers is formed to extend from over the first electrodes to the gaps between the first electrodes,
a resistance between two adjacent first electrodes generated by the at least the part of the organic compound layers in the gap between the two adjacent first electrodes is less than a resistance between one of the first electrodes and the second electrode generated by the organic compound layers disposed therebetween, and
the drive circuit supplies currents between the first electrodes and the second electrode during a first period, and during a second period in which the current supply is stopped, the drive circuit applies a voltage equal to or less than a light emission threshold value of the organic EL elements between the first electrodes and the second electrode.

2. The light-emitting device according to claim 1, wherein a length of the first period is less than an interval from a time when the drive circuit begins to supply currents to cause one of the organic EL elements to emit light, to a time when a voltage between the first electrode and the second electrode of the organic EL element adjacent to the light emitting organic EL element, to which the drive circuit supplies no current, exceeds the light emission threshold value of the organic EL element.

3. The light-emitting device according to claim 1,
wherein the first electrodes are arranged in a matrix,
the drive circuit includes scanning lines provided along the rows of the first electrodes, data lines provided along the columns of the first electrodes, pixel circuits connected to the first electrodes, and a common power supply connected to the second electrode, and
a selection signal is sequentially provided to the scanning lines for each row, voltages of the data lines are incorporated as data signals into the pixel circuits of a selected row, and currents corresponding to the data signals are supplied to the organic EL elements.

4. The light-emitting device according to claim 3, wherein the pixel circuits each include a drive transistor whose source and drain are arranged in series between a power source and the first electrode, a storage capacitor connected to a gate of the drive transistor, and a switch connected between the storage capacitor and the data line and controlled by a signal of the scanning line.

5. The light-emitting device according to claim 4, wherein an electric potential of the power source during the second period is closer in value to an electric potential of the second electrode than the electric potential of the power source during the first period.

6. The light-emitting device according to claim 3, wherein an electric potential of the common power supply during the second period is closer in value to an electric potential of the first electrode than the electric potential of the common power supply during the first period.

7. The light-emitting device according to claim 3, wherein the first period and the second period are switched in synchronization with the selection signal of the scanning line.

8. The light-emitting device according to claim 3, wherein the first period and the second period are each provided at least once within a period during which the selection signal of the scanning line is provided to all the rows.

9. The light-emitting device according to claim 3, wherein the first period and the second period are each provided once or more within a period during which the selection signal of the scanning line is provided to a row.

10. The light-emitting device according to claim 1, wherein the organic compound layers comprise a light-emitting layer and a charge transport layer and the light-emitting layer extends from over the plurality of first electrodes to the gap between adjacent first electrodes.

11. The light-emitting device according to claim 1, wherein the organic compound layers comprise a light-emitting layer and at least a charge transport layer and the charge transport layer disposed between the light-emitting layer and the first electrodes extends from over the plurality of first electrodes to the gap between adjacent first electrodes.

12. A display device comprising the light-emitting device according to claim 1 and
a control circuit that controls the light-emitting device.

13. An electrophotographic printer comprising the light-emitting device according to claim 1 and
a photoconductor to which light emitted from the light-emitting device is applied.

14. A method for driving a light-emitting device which comprises a plurality of organic EL elements and a drive circuit,
each of the organic EL elements including a first electrode which is formed on a substrate separately from the first electrode of an adjacent organic EL element with a gap, a second electrode disposed over the first electrode, and organic compound layers disposed between the first electrode and the second electrode,
at least a part of the organic compound layers being formed to extend from over the first electrode to the gap between the first electrodes of adjacent organic EL elements, and
a resistance between two adjacent first electrodes generated by the at least the part of the organic compound layers in the gap being less than a resistance between the first electrode and the second electrode generated by the organic compound layers disposed therebetween,
the method comprising:
alternately switching a first period during which the drive circuit supplies a current between the first electrode and the second electrode and a second period during which the current supply is stopped and the drive circuit applies a voltage equal to or less than a light emission threshold value of the organic EL elements between the first electrode and the second electrode.

15. The method according to claim 14, wherein the first period is switched to the second period before a voltage between the first electrode and the second electrode of an organic EL element adjacent to a light-emitting organic EL element, to which the drive circuit supplies no current, reaches the light emission threshold voltage of the organic EL element.

16. The method according to claim 14,
wherein the first electrodes are arranged in a matrix,
the drive circuit includes scanning lines provided along the rows of the first electrodes, data lines provided along the columns of the first electrodes, pixel circuits connected to the first electrodes, and a common power supply connected to the second electrode, and
a selection signal is sequentially provided to the scanning lines for each row, voltages of the data lines are incorporated as data signals into the pixel circuits of a selected row, and a current corresponding to the data signals is supplied to the organic EL element.

17. The method according to claim 16, wherein the first period and the second period are switched in synchronization with the selection signal of the scanning line.

18. The method according to claim 17, wherein the first period and the second period are each provided once or more within a period during which the selection signal of the scanning line is provided to a row.
